(19) United States
(12) Patent Application Publication
(10) Pub. No.: US 2025/0258010 A1
(43) Pub. Date: Aug. 14, 2025

(54) Systems and Methods for Navigational Guidance

(71) Applicant: Comcast Cable Communications, LLC, Philadelphia, PA (US)

(72) Inventors: Adam D. Eng, Golden, CO (US); David A. Eng, Louisville, CO (US)

(21) Appl. No.: 18/436,161

(22) Filed: Feb. 8, 2024

(51) Int. Cl. G01C 21/36

(52) U.S. Cl. CPC G01C 21/3685; G01C 21/3691

(57) ABSTRACT

Systems, apparatuses, and methods are described for determining parking locations for a desired destination and instructions on how to arrive at those parking locations. Parking locations may be determined based on past parking history of individuals that frequent the desired destination. The determined parking location may be based on the popularity of parking locations used by the individuals and/or may be weighted by destination specific choices concerning cost, distance, and/or other relevant details by a user seeking to go to the desired location.

### BACKGROUND

An individual may use a mapping application on a device to determine a route to a destination. The map application may provide accurate directions, that may consider current traffic patterns, construction issues, and/or other user desired parameters, to the destination. While the directions may take the individual to destination, the directions may leave the individual to find a suitable parking location after they arrive at the destination.

### SUMMARY

The following summary presents a simplified summary of certain features. The summary is not an extensive overview and is not intended to identify key or critical elements.

Systems, apparatuses, and methods are described for determining, and instructions on how to arrive at those parking locations parking locations, for a desired destination. Mapping applications are ubiquitous on devices, and detailed instructions on how to reach a desired destinations may be obtained by giving a device detail of the desired destination. The instructions may consider present traffic patterns, accidents, and/or toll costs to provide the timeliest path to the desired destination. The instructions may provide details to the desired destination, but, unless the desired destination is a parking location, the user of the mapping application may have to find a place to park. By analyzing the past parking history of individuals that visit the desired destination, instructions may be provided to a user to find a place to park. By including appropriate destination specific questions, moreover, the mapping application may provide a user with details to find the parking location that best meets their preferred place to park for a desired destination. A user may input a destination request to their device. Based on the destination request a set of potential parking locations and routes to the parking locations may be determined based on how other people arrived and parked when they went to the desired destination. Selected parking locations and the directions to those locations may be shared with a user for the user to choose the parking location they would like to use.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIGS. 3a and 3b show examples of a route to Ronald Reagan Washington National Airport.

FIGS. 4a and 4b show examples of routes to a restaurant and the restaurant's parking locations.

FIG. 5a shows an example flow diagram of parking locations and final approach data being determined actively.

FIG. 5b shows an example flow diagram of parking locations and final approach data being determined passively.

FIGS. 6a and 6b show example tables that may be used for final approach parking.

FIGS. 7a and 7b show example flow charts for determining final approach parking directions to a parking location based on receiving a request for the location of a desired destination.

FIG. 7c shows an example flow chart for using destination specific questions to choose a parking location.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

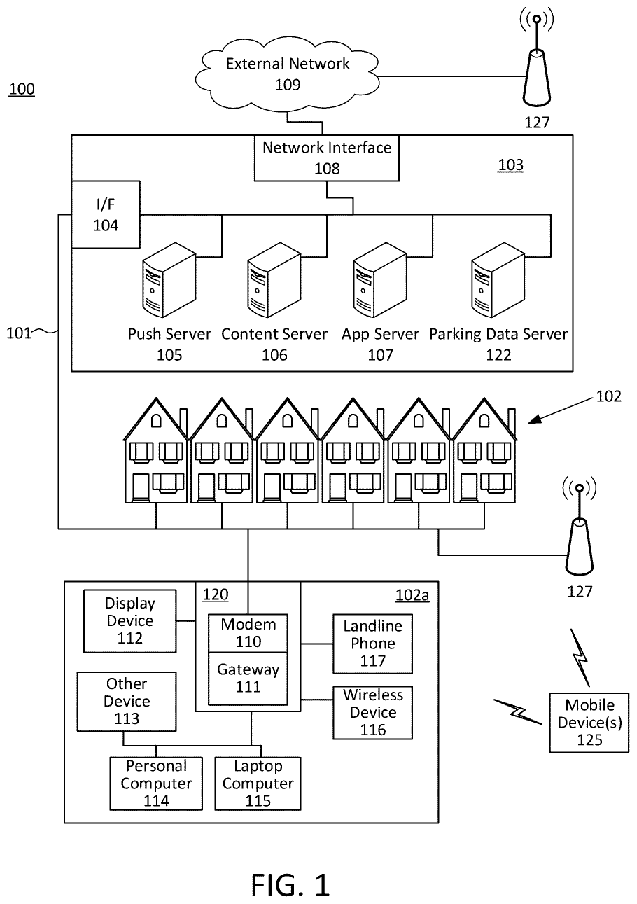

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as a parking data server 122, additional push, content, and/or application servers, and/or other types of servers. The parking data server 122 may monitor parking and/or location data of visitors to destinations and collecting that data to determine potential parking locations for a user. Although shown separately, the push server 105, the content server 106, the application server 107, the parking data server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on-or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

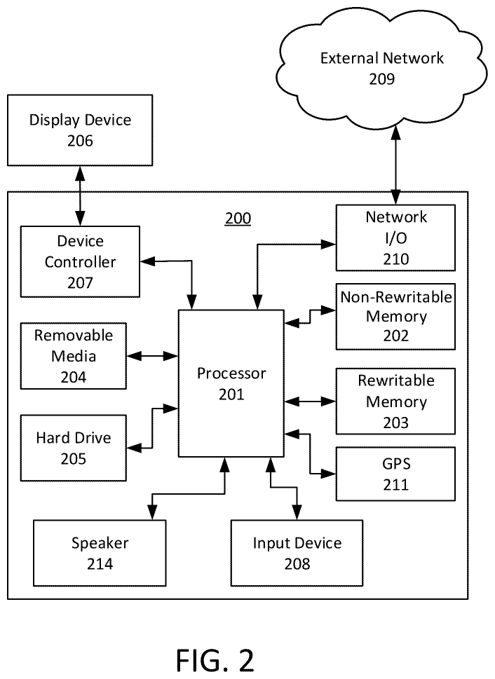

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., wireless phones, wireless tablets, wired and wireless computers, etc.). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer. Any of the methods described below may be implemented by a computing device 200 (e.g., a wireless phone, a wireless tablet, a personal computer, a wireless laptop, etc.).

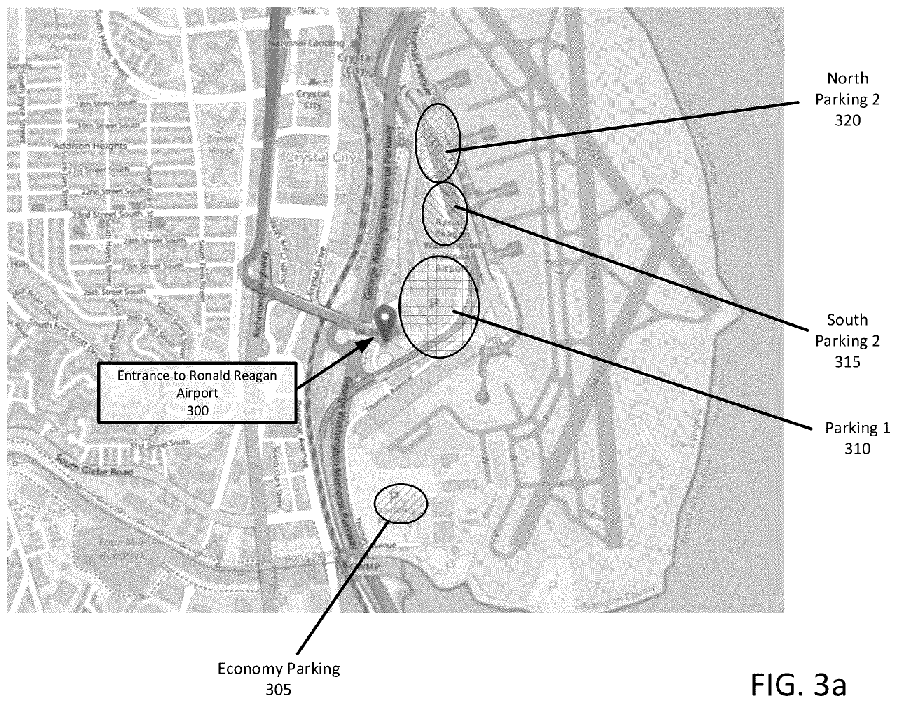

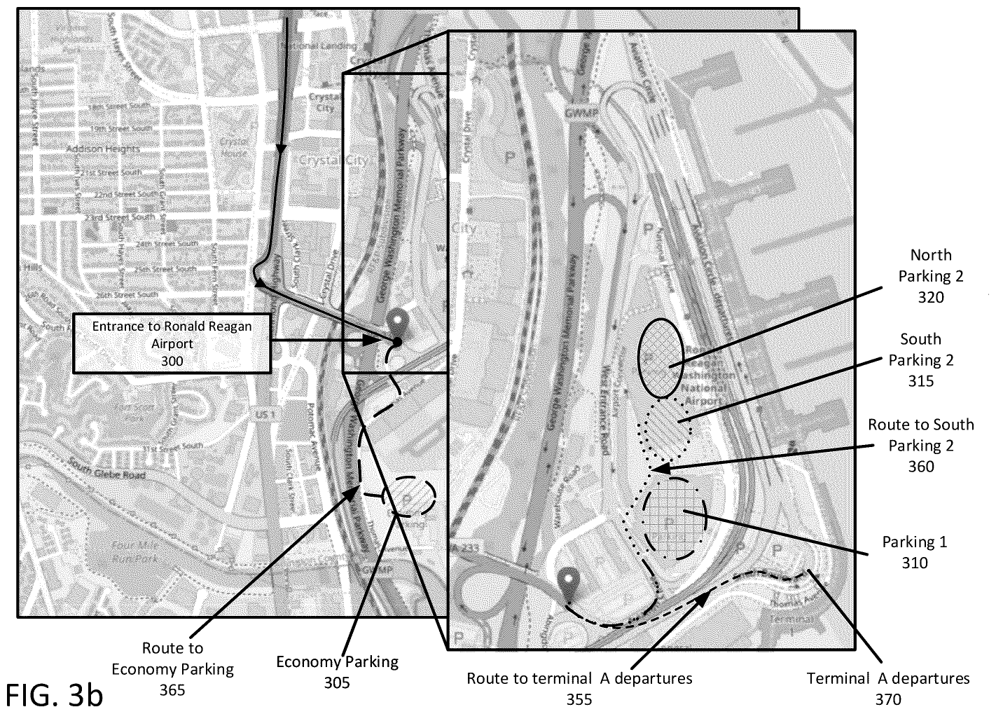

FIGS. 3a and 3b show examples of a route to Ronald Reagan Washington National Airport. FIG. 3a shows an example of a route to Ronald Reagan Washington National Airport. The route, as given in FIG. 3a, only provides details to arrive at the entrance of Ronald Reagan Washington National Airport 300. A person using the directions would have to follow signs to a departure gate, an arrival gate, and/or parking (e.g., economy parking 305, parking 1 320, south parking 2 315, or north parking 2 320). Because Ronald Reagan Washington National Airport has more than one terminal and several parking structures and locations (e.g., economy parking 305, parking 1 320, south parking 2 315, or north parking 2 320), an individual may easily end up at an incorrect location. Mapping applications may consider traffic patterns, notifications of accidents, time of day, toll costs, etc. to find the quickest and/or most cost-effective way to reach a destination. The applications, however, do not consider location of parking, cost of parking, and/or the ultimate destination to determine where a driver may park and/or the best way to reach that parking location. A final approach to a parking location may be determined by analyzing where other drivers park, and how they reach that parking location (e.g., crowdsourcing), for example, if the drivers at some point go to the desired destination. Also, or alternatively, a final parking location may be determined, for example, based on a series of destination specific questions. The destination specific questions may comprise one or more questions relevant to the desired end location. For travelers to Ronald Reagan Washington National Airport, for example, questions that may assist in determining the final location may comprise whether the individual is going to the airport to work, to travel, to drop someone off and/or to pick someone up at the airport; which airline and/or terminal the individual may need to reach; the cost of the parking; the lighting and/or safety of the parking; the time of day and/or the density of vehicles in a particular lot.

Routes, to locations that have been determined to fit destination specific questions, may be determined. Routes to a first parking location and/or a second parking location may be determined, for example, if the first parking location and/or the second parking location are determined to be the parking locations that fit the user's desired location and/or destination specific questions. FIG. 3b shows a route to terminal A departures 355, a route to a first parking location 360 (e.g., south parking 2 315), and a route to a second parking location 365 (e.g., economy parking 305). A driver seeking directions to Ronald Reagan Washington National Airport 300 may be provided a route to terminal A departures 355, for example, if destination specific questions determined that the driver is dropping off an individual that is departing on a Southwest Airline flight (e.g., that departs from Terminal A departures 370). A driver seeking directions to Ronald Reagan Washington National Airport 300 may be provided a route to south parking 2 360, for example, if destination specific questions determined that the driver wanted the shortest walk between parking to reach the United departure terminal. A driver seeking directions to Ronald Reagan Washington National Airport 300 may be provided a route to economy parking 365, for example, if destination specific questions determined that the driver desired to pay the lowest cost and still park at the airport. The application may also provide information on shuttle schedules from the economy lot to a desired terminal and/or provide a method to hail a driver to pick up and take the driver to the desired terminal.

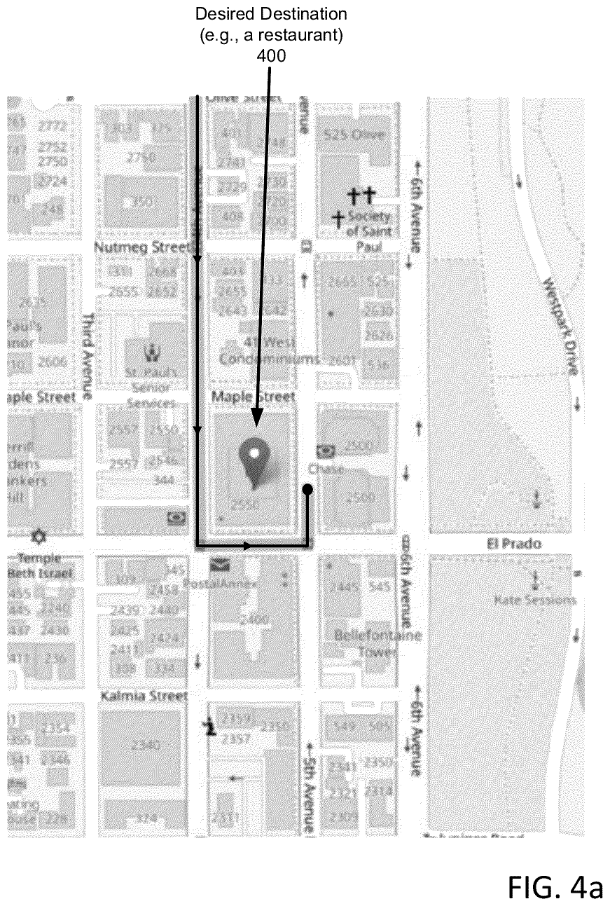

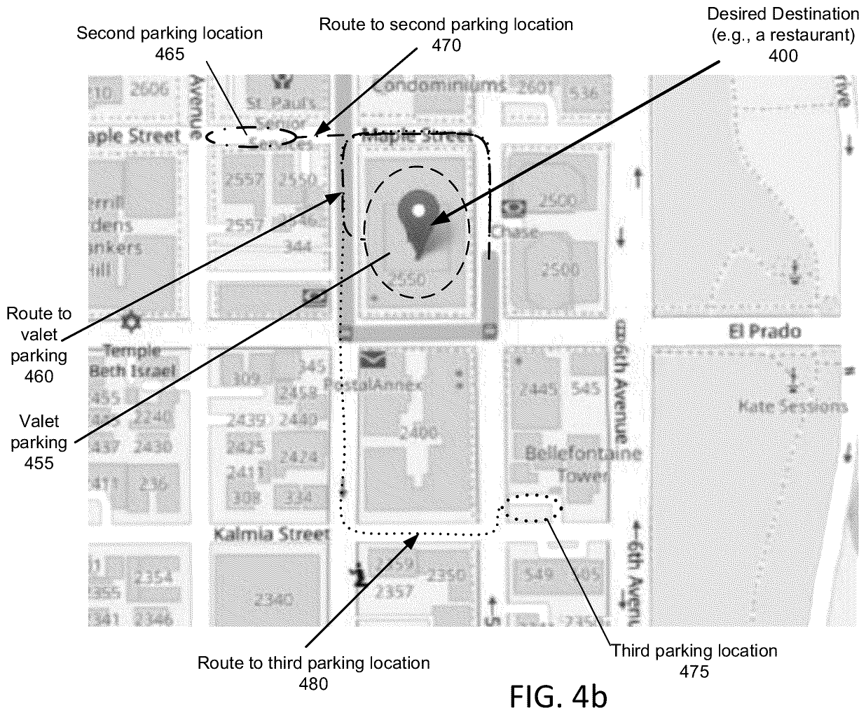

FIGS. 4a and 4b show examples of routes to a restaurant and the restaurant's parking locations. A driver seeking to reach a restaurant may enter the name of the restaurant or the address of the restaurant, for example, and FIG. 4a shows an example route to the restaurant (e.g., desired destination 400). The driver may not need to park, for example, if the driver is dropping off a rider. Conversely, the driver may have a reservation and may need a place to park. The driver may not possess the information necessary to find parking and may simply drive around looking for the first available spot.

FIG. 4b shows example routes to a restaurant's parking locations. A route to valet parking 460 associated with the restaurant 400, a route to a second parking location 470 (e.g., street parking 465) within a 5-minute walk from the restaurant 400, and a route to a third parking location 480 (e.g., a parking lot 475) within a 15-minute walk to the restaurant 400, for example, are shown. A driver seeking directions to the restaurant may be provided directions to valet parking 455, for example, if destination specific questions determined that the driver is willing to pay the valet fee and a tip. A driver seeking directions to the restaurant may be provided directions to the second parking location 465, for example, if destination specific questions determined that the driver does not want to pay for parking and is willing to walk to save money. A driver seeking directions to the restaurant may be provided directions to the third parking location 475, for example, if destination specific questions determined that the driver would rather pay less for parking and is willing to walk a short distance.

Desired destinations may comprise businesses (e.g., restaurants, stores, etc.), community gathering places (e.g., parks, golf courses, stadiums, etc.), and/or transportation hubs (e.g., airports, bus stations, train terminals, etc.). Relevant parking locations may be limited by a threshold distance. The threshold distance may be a mile by default, for example, but may be a setting a user may change. Relevant parking locations may be based on the time of day, the day of the week and/or year. Relevant parking locations may be based on events. Relevant parking locations may advertise and/or offer incentives. Details and/or data for relevant parking locations around a desired destination may be determined actively and/or passively. Details and/or data for relevant parking locations may be monitored and/or stored for distances greater than the threshold distance.

Parking locations and navigation to the parking locations may be determined by collecting parking and navigation data of individuals that frequent the desired destination (e.g., crowdsourcing). Individuals may volunteer to provide their data and/or data may be collected from data brokers. A business may actively seek a group of volunteers (e.g., crowdsourcing) by offering something in exchange for allowing the business to track the volunteer. A restaurant may offer a discounted appetizer, for example, if a volunteer turns on location services concerning an application on a wireless phone. With the location services enabled the final approach to a parking location near the desired destination may be determined with the tracked data (e.g., by following the path the device takes to the parking location). An application associated with an airline and/or an airport, similarly, may seek permission to enable tracking of a wireless device. The application of the airline and/or airport may further incentivize a user to enable tracking by offering additional services (e.g., parking timer tracker, prepaid parking permits, time to boarding, etc.). Moreover, the application of airline and/or airport may track a wireless device within an airport and offer relevant ads for restaurants and/or shops near the user's location. Similarly, a mall may have a rewards program, for example, for individuals that go the mall a certain number of times. Rewards may be based on destinations the individual visits while at the mall. This may incentives visitors to the mall to have their destinations determined, the parking location they chose determined, and the final approach they took to their chosen parking location determined.

This method of collecting data from a group of individuals (e.g., crowdsourcing) may benefit local businesses that have repeat customers. Because this method of collecting data from a group of individuals (e.g., crowdsourcing) may be directed towards individuals that visit certain destinations more often, this method may capture the route that individuals that are local and/or that visit a destination more often may take, as well as the locations where they may park. By collecting the data from multiple volunteers (e.g., crowdsourcing) preferred paths may be determined. It may be determined, for example, that people that frequent certain locations may take a path that bypasses a particular intersection because the light takes too long and/or they may cross a first parking location to reach a second parking location because it does not travel around the destination unnecessarily.

Also, or alternatively, parking and navigation data may be collected from data brokers. Parking and navigation data may be determined by determining wireless devices that may come within a known radius of a destination. Parking locations may be determined within the known radius, and the navigation to those parking locations may be determined by using the location data associated with the wireless device as it approaches a parking location. Moreover, exiting paths may be determined to assist in leaving a location (e.g., leaving a heavily used malls). Also, or alternatively, an application may focus on collecting this type of data. A map application, for example, may track locations. An application may provide parking location and navigation data to parking locations, for example, if the user agrees to having their location tracked.

A data set of individual (e.g., crowdsourcing) parking habits and navigation methods of the individuals may be determined from sets comprising destinations, parking locations, and/or navigation instructions. This method may collect large data sets comprising many different individuals (e.g., crowdsourced). Analyzing the final approach to parking locations of a large number of individuals (e.g. crowdsourcing) may lead to details that certain routes should be avoided. Certain turns may have long lights and/or may be difficult at certain times of day, for example, that individuals that know the destination may purposely avoid. Directions may be modified to bypass certain roads and/or routes based on the collected data sets. Results of this method may also show evolving navigation and/or parking location choices. Individuals may park in different parking locations and/or take different routes to parking locations, for example, based on changing road conditions (e.g., from weather, traffic, construction, etc.).

Parking locations around a restaurant may be determined actively, for example, by the restaurant gathering parking locations within a certain radius. Parking locations may include valet parking, designated parking lots, non-metered street parking, metered street parking, etc. A restaurant and/or a business may provide an incentive to potential customers via an application (e.g., crowdsourcing). The application may monitor and collect location data of the phone associated with the potential customer, for example, to gather the route and parking location the customer takes to the restaurant and/or business. The incentive may be sent to people that live locally and/or people that frequent the restaurant and/or business, for example, to determine how a person with knowledge of the surroundings get to the location and where they park (e.g., a local's route and parking spot). An individual with knowledge of the area (e.g., a local) may realize, for example, it is more efficient to enter a parking lot from a certain direction and/or which parking lots have the most open spaces.

Parking locations around an airport may be determined actively, for example, by the airport determining available parking structures associated with the airport. The airport may determine additional parking locations, for example, by including lots not associated with the airport, but that may provide shuttle or transport services to the airport. The airport may monitor, and store data related to traffic into and/or out of the available parking structures (e.g., crowdsourcing). The airport may monitor, and store data related to parking availability and/or usage. The airport may use an application for users to prepay and reserve parking spots. The application may have a location tool that allows the location of the device having the application to be monitored and stored for times near (e.g., 1 to 2 hours before to 1 to 2 hours after) the reservation time to determine a popularity of a parking location.

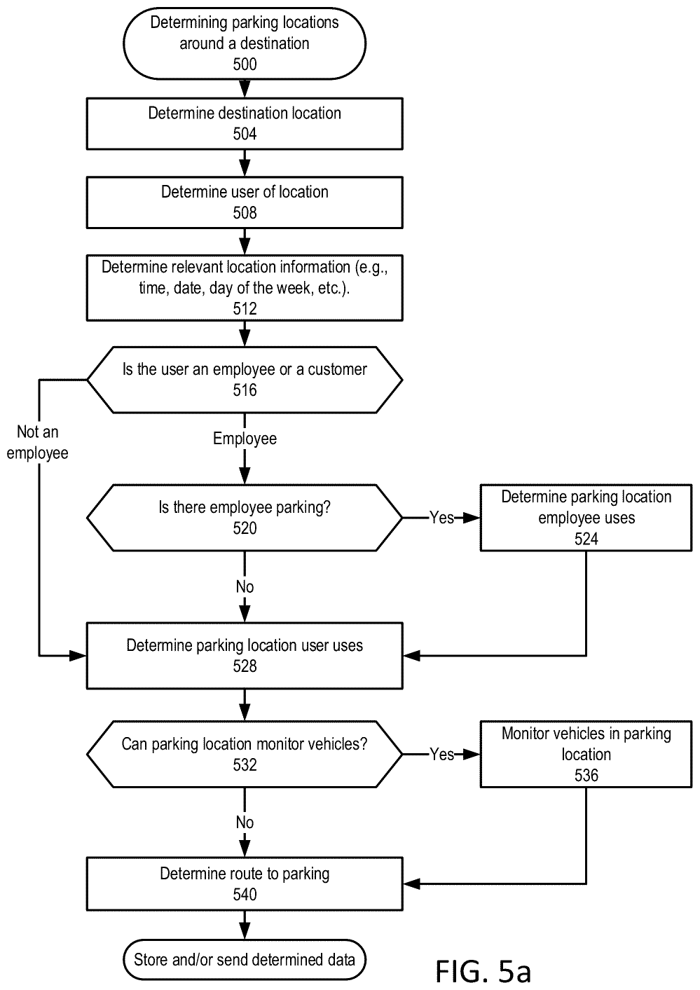

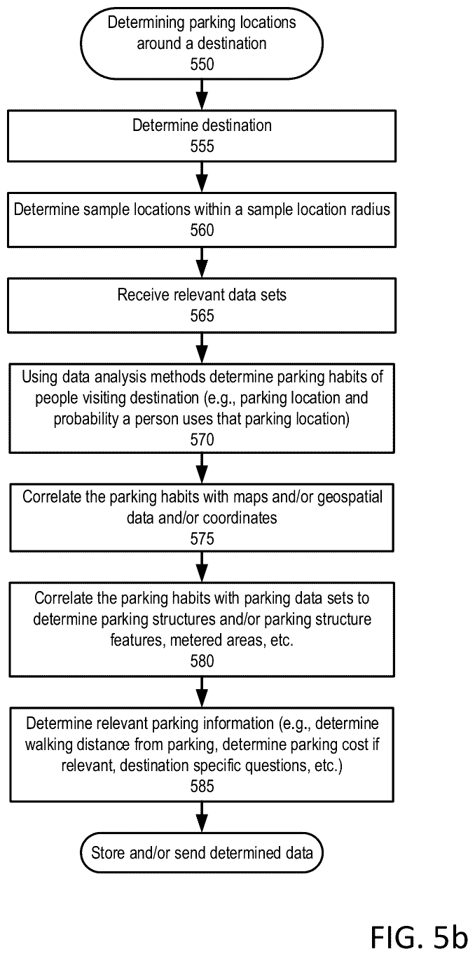

FIG. 5a shows an example flow diagram of parking locations and final approach data being determined actively. Actively determining parking location and final approach data may include actively monitoring a user to a parking location and/or determining their final approach to the parking location (e.g., crowdsourcing). In step 504, a destination location for which parking locations and final approach data may be determined. The destination may be a business in a mall. The destination may be a restaurant near a terminal at an airport. The destination may be a haberdashery in a neighborhood shopping center.

In step 508, a user of a destination may be determined. A user may be a type of individual that may go to the destination. A user, for example, may be a customer, a visitor, or an employee. Different users may have different types of parking available to them and/or may seek different types of parking locations (e.g., crowdsourcing). A parking location designated for employees may be an appropriate parking location, for example, if the user is an employee. A parking location designated handicap may be an appropriate parking location, for example, if the user has access to handicap parking. A parking location further away may be an appropriate parking location, for example, if shuttle service between the parking location and destination is available. Determining a user of a location may be based on destination specific questions.

A user may be determined based on the user going to a destination. A user may be enticed into going to a destination by an online coupon and/or advertisement. The user may agree to receiving a coupon and enable tracking information. The user may scan a quick response (QR) code at a destination that may provide a list of services (e.g., a menu) and/or a discount on those services, for example, in exchange for the user device being tracked for a period of time. The user may return to their parking location and use a route to leave the area of the destination, for example, during that period of time. A user may be determined based on the user using an app. The app may be related to the destination the user may be going to and/or at. The destination may provide an online reservation system that a user may use. A user may prepay for a parking spot at a parking location, for example, if the user plans to park at Ronald Reagan Washington National Airport. The prepay app may inform the user the day of the trip and provide functions that entice the user in keeping the app operating, for example, so that the app may monitor user location. The destination may provide a ticketing app. The destination may provide an online shopping experience. An app may include tracking capabilities that a destination may use to gather parking and final approach data.

A user may be determined by signing on to a local WI-FI network. The WI-FI network may track the user as the user moves around the area covered by the WI-FI network. A mall or an airport, for example, may have a WI-FI network that covers the destination and/or nearby parking structures. The path the user takes from the destination to their vehicle may be determined. The location of the vehicle may be determined, for example, based on a change in speed of the user's device. The parking location may be determined, for example, as the location where the user's speed changed from their walking pace to something faster. The location of the parking location may be determined based on the user's device following roads. The parking location may be determined, for example, based on a user exiting a parking location and the user's location then following roads.

Many modern vehicles have vehicle-to-vehicle (V2V), vehicle-to-network (V2N), and/or vehicle-to-everything (V2X) communications available. V2V communications allow vehicles to share data amongst vehicles equipped with V2V; V2N communications allow vehicles to share data over wireless networks; and V2X allows vehicles to share data and communicate with other cars, infrastructure (e.g., a parking structure equipped with the proper technology), and/or a user's device. Moreover, V2X communications are becoming more common allowing parking locations to have the vehicles parking in the parking location to inform the parking location that they have parked in the parking location and inform the parking location of parking density around the vehicle.

In step 512, relevant information that may affect parking may be determined. Parking location availability may change, for example, based on time of day, day of the week, seasons, and/or other events. Parking location and/or final approach data may take in account the relevant information. The parking location and/or final approach data may suggest a first parking location and/or a first final approach for a destination, for example, during the summer, or the parking location and/or final approach data may suggest a second parking location and/or a second final approach for a destination, for example, during the winter.

It may be determined if a user has access to special parking availability. A user may be an employee, for example, and have access to employee parking. A user may be eligible to park in handicap designated parking locations. A user may have taken a shuttle from the parking location to the destination. In step 516, it may be determined, for example, if the user is an employee or a customer. Determination of employee status may be a question to the user and/or a database relating an identification of a user device, to an employee. Determination may be made based on how often the user goes to the destination and/or how long a user remains at a destination. A user may be determined to be an employee, for example, if the user is at the location several times a week and remains at the location for periods of times greater than four hours per visit. The period of time may be varied depending on the location and user habits. Users going to an athletic event may spend more than four hours at the location, for example, even if they are not employees. A user may be determined to be an employee at an athletic event, for example, if they arrive several hours before the start of the event and/or remain several hours after the ending of the event.

It may be determined in step 520 whether employee parking is available or not, for example, if it was determined in step 516 that the user is an employee. Employee parking may be determined based on a list of parking locations that are designated for employees, or an indication that employee parking is not available. It may be determined in step 520 if other types of parking are available. It may be determined that a user may be eligible for other types of parking (e.g., handicap, special parking status, valet, etc.), for example, if other types of parking are available.

In step 528, it may be determined which parking location a user uses. The parking location may be determined, for example, based on a location determined by the user's use of a WI-FI network. The parking location may be determined, for example, based on tracking methods used by an app associated with the destination. The parking location may be determined, for example, based on V2X determining a change in nearby objects.

In step 532, it may be determined if a parking location may monitor use of the parking location. A parking location may monitor vehicle entry and/or exit. The parking location may have cameras at an entry and/or placed throughout the parking location. Cameras at parking location may collect and/or store vehicle data. Vehicle data may include color of the vehicle, vehicle make and model, and/or license plate information. Data may be encrypted and/or designed to be destroyed after a period of time if a vehicle exits the parking location. A vehicle's path through a parking location may be derived based on the camera data.

A parking location may monitor available and/or unavailable parking spots in a parking location. Cameras and/or proximity sensors may determine available and/or unavailable parking locations. V2X communications may be used to determine density of available and/or unavailable parking spots based on vehicles determining if other vehicles are parked around it.

A parking location may monitor vehicles exiting the parking location (e.g., crowdsourcing). Cameras may monitor vehicle characteristics to determine the vehicle is leaving the parking location. A parking location may determine when a vehicle enters a parking location, where in the parking location the vehicle parks, when the vehicle leaves the parking location, and/or a length of time that the vehicle may have been in the parking location, for example, if the parking location monitors vehicles entering, parking in, and/or leaving the parking location.

A user may be correlated with a vehicle and/or vehicle information based on the user location matching the vehicle parking location within an error distance that may be associated with determined location data for a minimum amount of time. Multiple monitored users may approach a vehicle within the error distance, but, in most cases, the time a monitored user may be within the error distance will be less than the minimum amount of time threshold. A user that enters and uses a vehicle, for example, will be within the minimum distance and will remain in the minimum distance of the vehicle. A vehicle equipped with V2X may also send an indication that may indicate the user entered the vehicle.

In step 540, a route a vehicle takes to a parking location may be determined. A route of a vehicle may be determined by continuing to determine a location of a user while the user may be using the vehicle. The user's location may continue to be determined, for example, if location services remain enabled for the user's device. The determined location of the vehicle, based on the determined location of the user, may be correlated with streets and/or highways. The route the vehicle takes from the parking location may be determined based on the determined vehicle locations over time. The route from the parking location may be used to determine a route to the parking location. The route may be reversed and any single directions roadways may be accounted for by using matching single direction roadways that go in the opposite direction or by using other detour methods.

Also, or alternatively, big data analytics, artificial intelligence, and/or machine learning may be used to analyze the parking habits of others (e.g., crowdsourcing) that have visited the restaurant and/or other locations near the restaurant. Location services associated with phones provide a great deal of data where people visit and how they reach those locations, including parking. Big data analytics may provide a number of parking options for a driver, for example, analytics may determine that valet parking associated with a building the restaurant is in may be available around a corner, that there are multiple pay parking lots that typically have available spots at the current time less than a half-mile away, and/or there is unused public parking at a local library that is available for use for local businesses outside of the library's normal hours a half-mile away. By combining big data analytics (e.g., crowdsourcing) with context choices, a driver may be provided with optimal parking locations. The driver may receive the details of the local parking locations and by using destination specific questions the parking best suited for the driver's needs and/or desires may be determined. The driver may determine that valet may be the best option, for example, if it is dark and the driver does not feel comfortable walking in the dark. The driver may determine that the library parking may be the best option, for example, if saving money is the driver's highest priority. Other destination specific questions may be asked, for example, including does the driver plan on going to a second destination after the restaurant, does the driver plan on meeting other people, and/or how long the driver plans on being at the restaurant and/or how long the parking services may be available. A driver may not want to use valet parking, for example, if valet parking is only available through a particular time and the driver plans to visit a nearby bar after the restaurant to meet another individual.

FIG. 5b shows an example flow diagram of parking locations and final approach data being determined 550 using data analysis tools on collected data sets (e.g., crowdsourcing). The steps determining parking locations and final approach data may be performed in an order different than example 500. The parking locations may be correlated with map data, for example, before determining the parking habits. A destination may be determined 555. The destination may be business location without attached parking (e.g., a restaurant, a shop, etc.). The destination may be locations with parking structures (e.g., malls, amusement parks, airports, etc.). The destination itself may commission the parking location and final approach determination or the parking location and final approach determination may be part of a program to elevate a business location's profile.

A sample location radius may be used to determine an area of sample locations to include in collecting data. In step 560, the area to include in the sample locations to analyze may be determined. The area may be a circle of a set radius with a determined destination at the center. The sample location radius may be set by a default value. The sample location radius may be changed (e.g., via a setting and/or via a command).

Relevant data sets may be received. Relevant data sets may include location data of people that have entered a sample location area. Relevant data sets may be a location history of people that may have entered the sample location area. The location history may show where a person that enters a sample location area travels to before or after entering the sample location. The location history may be analyzed to determine parking data based on time of day, day of the week, and/or seasonally. The location history may be analyzed to determine parking data based on events that may occur. The location history may be correlated with other relevant data sets including parking location data sets, metered parking data sets, crime and/or reported crime data sets, and/or maps. In step 565, the relevant data sets (e.g., parking location data sets, location history of people that entered the sample location, metered parking data sets, etc.).

Parking habits of people (e.g., parking locations and/or a probability a person uses those parking locations) that enter a sample location area may be determined (e.g., crowdsourced) by analyzing data sets comprising relevant data. In step 570, the parking habits of people that visit the sample location area may be determined. Data sets may be mined for statistical modeling data for creating predictive models. A parking location of a person may be determined, for example, based on a speed change. A speed change may be determined based on a change in distance per a change in time step. The parking location may be binned with other parking location data within a parking location area. The parking location area may be based on a circular area of a given radius. The parking location area may be a street. The parking location area may be a parking structure or a portion of a parking structure. Parking probabilities may be determined based on the fraction of people that enter a sample location area that park in a parking location area.

In step 575, parking locations may be correlated with parking data sets. The parking data sets may be related to parking structures, metered areas, maps, and/or geo-spatial data and/or coordinates. In step 580, relevant parking information may be determined. The relevant parking information may comprise, for example, walking distance from a parking location to a desired destination, a cost associated with the parking (e.g., meter costs, parking lot costs, etc.), and/or destination specific questions.

Details of a parking locations near a desired destination may be used to construct a table (e.g., a relational database, a graph, a chart, etc.) to determine parking locations. The table may comprise the desired destination and/or a second location within a threshold distance to the desired destination. The threshold distance may be a determined distance. The threshold distance may be a distance determined by a user. The threshold distance may be a distance determined by the business. The threshold distance may be determined based on an algorithm. Additional locations, furthermore, may be used (e.g., a third, a forth, etc.) to determine additional and/or context appropriate parking locations for a desired destination. A new restaurant may open in a local mall and use the parking locations for a nearby store and/or restaurant, for example, if parking data for the new restaurant has not yet been generated, but there are nearby stores and/or restaurants in the mall.

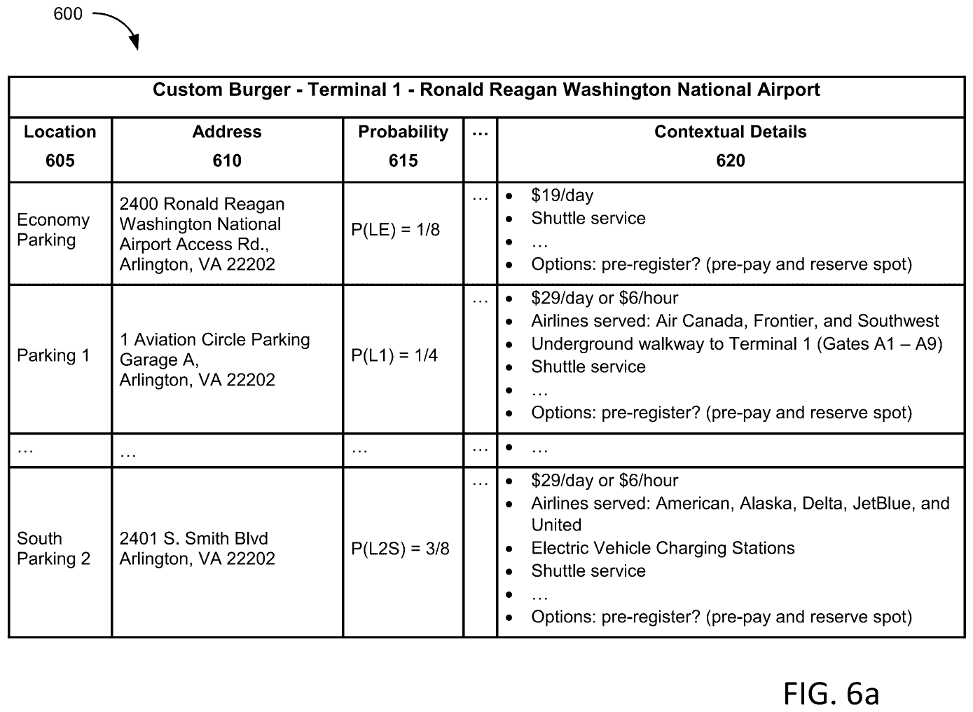

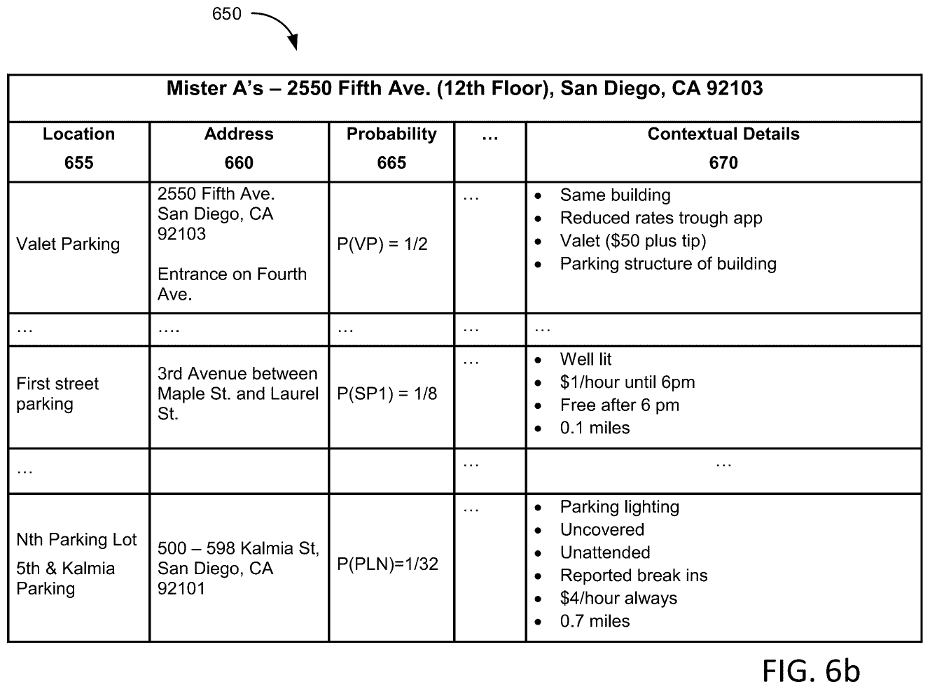

FIGS. 6a and 6b show example tables that may be used for final approach parking. Parking data tables may comprise data associated with parking around a desired destination. A parking data table may comprise nearby businesses, restaurants, and/or shopping. Parking data tables may comprise a price, availability of shuttle service, EV charging, and/or distance to terminals, for example, if the desired destination is an airport and/or a location within the airport. A desired destination may be a place to eat within an airport terminal, for example, if a user is meeting a fellow traveler before travelling. An application may suggest a restaurant to visit, for example, based on an airline a user may be flying on. A restaurant may provide a discount (e.g., a coupon) to a user, for example, if the desired location is an airline and the restaurant is in the same terminal as the airline. The user may be an employee of the restaurant. The user may be looking for a place to eat and/or a place to have a drink before their flight. A parking data table may comprise flags and/or tags indicating certain parking locations may have placed ads to notify users of that the parking location is available. The ads may comprise terms for lower priced parking, terms for free shuttles, terms for a free detail, etc., for example, in exchange for using that parking location.

FIG. 6a shows an example parking data table for a restaurant in an airline terminal. A parking data table 600 for a restaurant in an airline terminal may comprise a location 605, an address 610 and/or geospatial data of the location 605, a probability 615 a person may choose that location 605, and/or contextual details 620 of that location. The probability 615 of a location may indicate popularity of the location. The greater the probability a user may choose a location, for example, indicates the choice is more popular with users. Other relevant data may be included in a parking data table 600. Other relevant data may include, for example, different parking locations for employees and customers, distance (e.g., walking distance) to the desired destination, reports of vehicle break-ins, reports of assault and/or battery, ease of getting into and/or out of the parking location (e.g., convenience). Other relevant data may include preferred driver recommendations, for example, for people that go to the desired destination more often. A preferred driver recommendation may be used to weight a selected parking location more heavily, for example, if the driver frequents the location. A driver that frequents a location may have a better idea of available parking at a given time. A frequent flier may have a better idea of open areas in a parking structure at an airport, for example, because the frequent flier has parked at the location more often than a person that flies infrequently.

A location 605 in a parking data table (e.g., for a restaurant in Ronald Reagan Washington National Airport 600) may comprise a name of a parking location and/or a description of the parking location. The parking data table 600 may comprise one or more parking locations. A parking location 605 may comprise a parking location associated with the desired destination (e.g., the parking lots associated with an airport). A parking location 605 may comprise a parking location unassociated with the desired destination (e.g., a commuter lot providing transportation to an airport, street parking near the desired destination, etc.). A parking location 605 may provide incentives to entice a user to choose that parking location 605. The parking location 605 may provide a discount to park at that location, for example, if the user chooses that location 605.

An address 610, or geospatial location, of a parking location 605 in a parking data table (e.g., for a restaurant in Ronald Reagan Washington National Airport 600) may comprise a physical address and/or geospatial coordinates of the location 605. An address 610 and/or geospatial location may be used to determine a distance between a desired destination and a potential location 605. An address 610 may be used to determine accessibility of a location 610. The location 605 may be inaccessible, for example, if the parking location 605 is under construction, if the location 605 is near an accident, and/or if the parking location 605 is blocked to general access. An address 610 may be used to determine directions from the parking location 605 to the desired destination.

A probability 615 of a parking location 605 in a parking data table (e.g., for a restaurant in Ronald Reagan Washington National Airport 600) may comprise a fraction of a number of times a parking location may be selected by a person that may be going to a desired destination. A probability 615 may be used to determine the likelihood that a location 605 may be used by an individual as a parking location, for example, if they go to a desired destination. The probability 615 may be based on time, day, and/or date. The probability 615 may be based on events occurring around and/or near the desired destination. The probability 615 may be based on weather at the desired destination. The probability 615 may comprise alternate paths (e.g., a safe passage information) to travel from the parking location 605 to the destination. An alternate path may include skyway paths (e.g., the skyways in Minneapolis, Minnesota) connecting buildings that may allow a person to travel from the parking location 605 to the destination inside and protected from weather conditions. The total probability 615 of all locations 605 may be equal to one, for example, if the probability 615 of each location 605 is the fraction of all locations 605.

A user may prefer one parking location over another. The user may only be concerned with parking as close to a desired destination as possible. Alternatively, the user may want to save money over walking a short distance. A user may want to park in a covered lot rather than walk a short distance. A user may be want to charge their electric vehicle while they park. Destination specific questions provide a means for a user to rank parking based on what the user finds important in a parking location at the desired destination. A user may be interested in safety. A user may be interested in keeping their car clean and/or protected. A user may wish to visit other locations before and/or after going to the desired destination.

Destination specific questions may be ranked by how often users answer the questions. EV charging may be wanted more often than hydrogen fuel cell charging, for example, if both are destination specific questions. Parking location cost may be less important than the availability of a shuttle, for example, if the desired destination has several parking locations nearby with similar cost but having different access to a shuttle service.

Destination specific details 620 of a parking location 605 in a parking data table (e.g., for a restaurant in Ronald Reagan Washington National Airport 600) may comprise one or more destination specific details. Destination specific details may comprise details that may affect a user's decision in choosing a parking location. Destination specific details may be based on a desired destination. Destination specific details may be based on an area around a desired destination. Destination specific details for parking associated with an airport terminal as a desired destination may comprise details associated with parking at an airport. Destination specific details for determining a parking location that may be based on a desired location being an airport may comprise, for example, the cost of the parking location 605, if shuttle service is available at the parking location 605, if electric vehicle (EV) charging is available, and/or airlines served.

FIG. 6b shows an example parking data table for a restaurant in a neighborhood. The restaurant may be in a mall, the restaurant may be in a commercial building, the restaurant may be in a retail building, and/or the restaurant may be free standing. A parking data table for a restaurant and/or a business may comprise details based on where a restaurant and/or business may be. A parking data table for a restaurant and/or business may comprise a parking lot that may be associated with a mall, for example, if the restaurant and/or business are in a mall. A parking data table for a restaurant and/or business may comprise a parking lot and/or street parking, for example, if the restaurant and/or business is in a commercial building, a retail building, and/or is free-standing.

A parking data table 650 for a restaurant in a neighborhood may comprise a location 655. A location 655 may comprise a name and/or description of a parking location. The parking data table 650 may comprise one or more parking locations. A location 655 may comprise a parking location within a certain distance from a desired destination (e.g., parking locations within a mile, two miles, etc.). A location 655 may provide incentives to entice a user to choose that location 655. A parking location 655 may allow certain destinations to validate for parking at the parking location 655. A parking location 655 may provide services to enhance the destination. A parking location 655 may provide a coupon for the desired destination.

A parking data table 650 for a restaurant in a neighborhood may comprise an address 660 and/or geospatial coordinates. An address 660 and/or geospatial location may be used to determine a distance between a desired destination and a parking location 655. An address 660 may be used to determine accessibility of a location 655. The location 655 may be inaccessible, for example, if the parking location 655 is under construction, if the location 655 is near an accident, and/or if the parking location 655 is blocked to general access. An address 660 may be used to determine directions from the parking location 655 to the desired destination.

A parking data table 650 for a restaurant in a neighborhood may comprise a probability 665. The probability 665 may be used to determine a preferred parking location 655. A first preferred location may be the parking location 655 having a highest probability 665. The probability 665 may be considered popularity, for example, if parking locations 655 that are more popular are the parking locations that are more likely to be chosen.

A parking data table 650 for a restaurant in a neighborhood may comprise destination specific questions 670. Destination specific questions for a parking location 655 associated with a destination that may be a neighborhood restaurant may comprise, for example, if the parking location 655 is a parking lot or is street parking, the distance from the parking location 655 to a desired destination, if the parking location 655 is covered and/or is well lit.

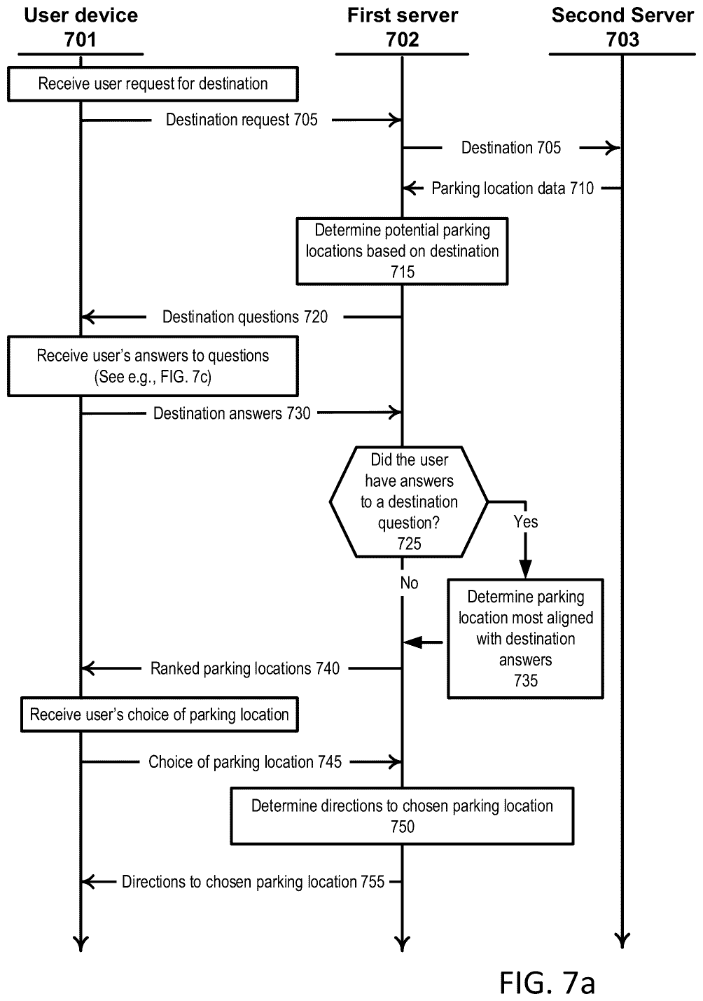

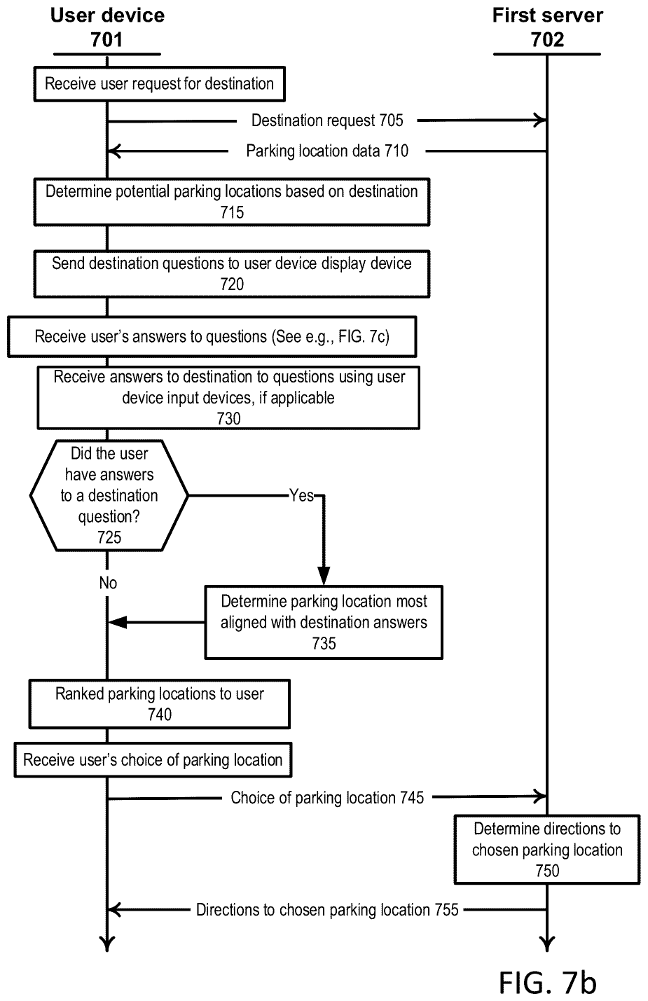

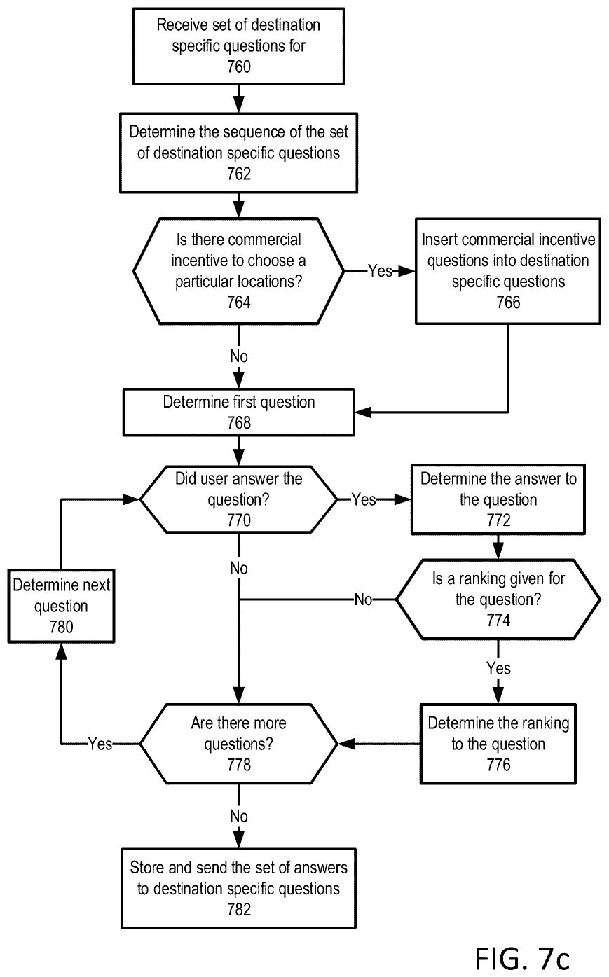

FIGS. 7a and 7b show example flow diagrams for determining final approach parking directions to a parking location based on receiving a request for the location of a desired destination, according to various aspects of the disclosure. FIG. 7a shows an example of a user device 701 sending details of a desired location to a server 702 and receiving a preferred lot that may be based on popularity data (e.g., crowdsourced) and/or on a series of location specific questions. In FIG. 7a, a first server 702 may pass and/or send location data to a second server 703 to receive parking location data. The second server 703 may be a part of the first server 702 of the parking location data may be contained on the first server 702.

In step 705, a user device may send a desired destination request to a server 702 (e.g., a first server), and the server may receive the desired destination request. The destination request may be made by the user to the user device using an input method. The destination request may be made, for example, by a user saying or entering in a text box, a name of a location (e.g., a name of a business), entering a uniform resource locater (URL) link from a search result of a search engine (e.g., a result for a search for a type of restaurant), inputting a physical address of a location (e.g., an address of a personal address), and/or geospatial data of a location (e.g., geospatial data that may be contained in digital photos.). The request may be made, sent, and/or received via wire and/or wirelessly.

In step 710, based on a desired destination, parking locations data associated with the desired destination may be received. A first server 702 may send the desired destination to a second server 703. The second server 702 may be a part of the first server 701. A server may be configured to do the operations of both the first server 701 and the second server 702. The second server 703 may send the parking location data to the first server 702. Alternatively, as described below in FIG. 7b, a user device may receive the parking location data.

The parking location data may be received as a parking data table as described herein in FIG. 6a or 6b. The parking locations data may comprise, for example, parking locations, their addresses and geospatial data, their distances to the desired destination, destination specific questions, and/or other relevant details of the desired destination. Relevant details may comprise distance to a terminal, parking time limits, parking costs, for example, if the desired destination is an airport. Relevant details may comprise walking distance, valet, covered parking, street or lot parking, for example, if the desired destination is a restaurant. The destination specific questions may be used to further refine a user's choice in parking location.

In step 715, one or more potential parking locations around a desired destination may be determined based on the desired destination's parking locations data and/or other non-contextual details. Non-contextual details are details that are not destination specific. Non-contextual details are details common to any parking decision. Non-contextual details may comprise, for example, the time of day, the season, the month, the date, etc. Non-contextual details may comprise, for example, known construction and/or other details that may limit access to a location. The parking locations may be ranked based on parking profiles of people parking to go to or come from the desired destination. A first potential parking location determined may be, for example, the parking location with the highest number of people parking (e.g., crowdsourced popularity, probability, etc.) to go to the desired destination on the day of the week and/or time of day the desired destination request is received 705. A second, third, and/or nth potential parking locations determined may be, for example, parking locations with the second, third, and/or nth number of people parking to go to the desired location on the day of the week and/or time of day the desired destination request is received 705. Other non-contextual details may alter the determined parking locations. The first potential parking location may be determined to not be the parking location with the greatest number of parkers, for example, if the parking location is under construction or repair, and/or if some other non-contextual detail makes the parking location non-accessible.

In step 720, any destination specific questions may be asked. Destination specific questions may be based on the context of the destination. A user may view the determined parking and/or desired destinations as a map with the desired destination and/or determined parking locations marked. The desired destination and potential parking locations may be shown on a display device of the user device 701. The potential parking locations may be highlighted and/or marked in some way indicating their initial rankings as determined in step 715. A route between each determined parking location and the desired destination may be marked (e.g., as described herein in FIGS. 3b and 4b).

One or more destination specific questions may be provided to a user in step 720. The destination specific questions may be included with parking location data received in step 710. The user may answer none, some, or all of the destination specific questions. The user may rate none, some, or all of the destination specific questions. The rating may indicate the importance of the destination specific questions to the user. The ratings of a plurality of users may be collected and used to create a default rank for one or more of the destination specific questions. An example method for acquiring the user's answers to the destination specific questions and the rank the user gave one or more questions is described below in FIG. 7c.

In step 730, answers to destination specific questions may be sent by a user device 701 and received by a first server 702, if a user answers any destination specific questions. One or more parking locations may comprise a group defined by an answer to a destination specific questions. A group may comprise the one or more parking locations having EV charging stations, for example, if the answer to a destination specific question is parking locations with EV charging stations. Similarly, a group may comprise the one or more parking locations having the same, or the same within a threshold, price to park, or a group may comprise the one or more parking locations having covered parking, if pricing or covered parking are destination specific questions.

Answers to destination specific questions may be ranked based on how a user may have ranked the destination specific questions. Answers to destination specific questions may be ranked on how often a destination specific question has been answered by other users. Destination specific questions may be considered more important, for example, based on the frequency the destination specific questions is answered. Price of parking may be ranked higher than covered parking as destination specific questions for a desired destination, for example, if the price of parking is answered more frequently than covered parking as a destination specific question for the desired destination.

It may be determined whether a user may have or may not have answered any destination specific questions. A button and/or a timer may cause a determination to be made whether a user may have or may not have answered destination specific questions. It may be determined, in step 725, that a user may not have answered any destination specific questions. It may be determined that a user may not have answered any destination specific questions, for example, if the user does not answer any destination specific questions and presses a done button. Also, or alternatively, it may be determined that a user may not have answered any destination specific questions, for example, if the user does not answer any destination specific questions and a threshold time limit expires. A threshold time limit may have a configured default value and/or may be set by a user.

Alternatively, it may be determined, in step 725, that a user may have answered destination specific questions. It may be determined that a user may have answered a destination specific question, for example, if the user answers at least one destination specific question and presses a done button. Also, or alternatively, it may be determined that a user may have answered a destination specific question, for example, if the user answers at least one destination specific question and a threshold time limit expires.

In step 735, a first destination specific parking location may be determined. A first destination specific parking location may be determined by weighting one or more primary parking locations determined in step 715 by ranked destination specific answers. Different weights for destination specific parking may be considered. A user may weight their destination specific answers more. A user may decide, for example, a low price to park is twice as important as parking within a tenth of a mile of a desired destination. Weights may be calculated on the number of destination specific questions answered. A user may only answer one destination specific question, so only parking locations in a group defined by that destination specific questions may be determined. Only parking locations having EV charging may be considered, for example, if a user only answered a destination specific questions asking if EV charging is desired. The first destination specific parking location may be determined to be the parking location with the greatest number of people (e.g., crowdsourced) using a parking location with EV charging available, for example, if the user only answered a destination specific question asking if EV charging is desired. A second destination specific parking location, a third destination specific parking location, and an nth destination specific parking location may be determined to be the parking locations with the second, third, and nth with the second, third, and nth greatest number of people using the parking locations (e.g., crowdsourcing) with EV charging available, for example, if the user only answered a destination specific question asking if EV charging is available.

In step 740, a set of parking locations (e.g., ranked potential parking locations, destination specific ranked parking locations, etc.) and/or a desired destination may be sent by a server 702 (e.g., a first server) to a user device. A user device 701 may receive location information for a desired destination and ranked parking location (e.g., crowdsourced ranked potential parking locations and/or ranked destination specific parking locations). These locations and/or routes between the ranked parking locations to the desired destination may be shown on a mapping application of the user device 701. The primary ranked parking locations and/or routes (e.g., crowdsourced) to a desired destination may be a first color and/or a first line format. The primary ranked parking locations and/or routes may comprise, for example, a solid yellow line. The secondary ranked parking locations and/or routes to a desired destination may be a second color and/or a second line format. The secondary ranked parking locations may comprise, for example, a dashed green line. The number of ranked parking locations may be limited to a maximum number. The number of ranked parking locations may have a default value and/or may be a parameter that a user may set.

A user may select a parking location from among a set of ranked parking locations. Ranked parking locations may be distinguished from each other. Ranked parking locations and their respective routes may be distinguished by comprising different colors and/or different line features. The user may select their desired route and/or parking location using appropriate input methods of the user device (e.g., touch screens, microphones, motion of the device, etc.). The user may highlight the route and/or the parking location they would like to choose, for example, by touching a route and/or a parking location on a touch sensitive device. The user may say the route and/or the parking location they would like, by saying the label name of the route and/or parking location.

In step 745, a user device 701 may send the selected parking location to a server 702, and a server 702 may receive the parking location selection. In step 750, directions to a selected parking location for a desired destination may be determined. The directions to the selected parking location may comprise directions from a current location to the selected parking location. The direction may include directions from the selected parking location to the desired destination. The directions from the selected parking location to the desired destination may comprise determining a route using methods appropriate to the location. A route from the selected parking location to the desired destination may comprise, for example, a walking route and/or a route using public transportation. A route from the selected parking location to the desired destination may comprise a pedicab, for example, if the destination has regular pedicabs. An application may have a hail a pedicab function as part of an ad program, for example, if pedicabs are available. The application may include suggestions for other businesses that may be on the route from the selected parking location to the desired destination. The suggestions may be based the desired destination and/or on answers to destination specific questions. A restaurant to have a meal before a movie starts may be suggested, for example, if the user's desired destination is a movie theater. A bar may be suggested, for example, if the desired destination is a restaurant.

In step 755, directions to a selected parking location for a desired destination may be sent. The directions to the selected parking location may be used to provide instructions using audio and/or visual guides. The directions may be presented as a map having the selected parking location, the desired destination, a route from the selected parking location to the desired destination, and/or a route from the user's present location to the selected parking location.

Alternatively, FIG. 7b shows an example of a user device 701 using parking location data (e.g., crowdsourced) that it receives from a server 702 to determine a parking location for a desired destination. The user device 701 may send a destination request, in step 705, to a first server 702, and the first server 702 may receive the destination request, in step 705. The first server 702 may send parking location data to the user device 701, and the user device 701 may receive the parking location data in step 710. The parking location data may be based on the desired destination.

In step 715 of FIG. 7b, a user device 701 may determine a set of potential parking locations using the parking location data and the desired destination. The potential parking locations may be based on a popularity score (e.g., crowdsourced) in the parking location data that may be based on the number of times a particular parking location is chosen from the parking location data.

In step 720 of FIG. 7b, a user device 701 may send a set of destination questions to a display device of the user device 701. The display device may be a touch screen. A user may answer none, some, or all of the destination questions. The user may indicate that the user may be done answering questions, and/or the user device may determine a timing threshold has been met and determine that the user may be done answering destination specific questions.

One or more destination specific questions may be provided to a user. Destination specific questions, as described herein, provide additional details to find parking locations and determine a final approach to the parking location that may better fulfil a user's parking location needs and/or desires. FIG. 7c shows an example flow chart for using destination specific questions to choose a parking location. In step 760 of FIG. 7c a user device 701 may receive a set of destination specific questions. A first server 702 may send the destination specific questions to a user device 701, for example, if the first server is doing the determination as described herein in FIG. 7a, or the user device 701 may receive (e.g., extract) the destination specific questions from parking location data as described above in FIG. 7b.

In step 762, a user device 701 may determine a sequence a set of destination specific questions are presented to a user. The sequence to present the set of destination specific questions may be the order they are listed in parking location data. Alternatively, he sequence to present the set of destination specific question may be based on a rank of the destination specific question. Destination specific questions may be ranked higher, for example, if they are selected more often by users (e.g., crowdsourced). Destination specific questions may be ranked higher, for example, if users rank them higher.

Destination specific questions may comprise a commercial incentive. A parking location may offer a discount a user, for example, if the user choses that parking location. A restaurant near one of the parking locations may offer a free menu selection to a user, for example, if the user chooses the parking location near the restaurant. A stadium may offer a user a discount at a snack bar, for example, if the user selects parking associated with the stadium.

In step 764, a user device may determine if there are commercial incentives to a particular location. The commercial incentives may be included in parking location data and/or a user device may receive commercial incentives separately based on details of the user, the user's location, the desired destination, etc. A destination specific question may ask the user if they would like to save money, for example, if a parking location is offering discounts to boost their occupancy. A parking location near a service offering shuttles may provide destination specific questions about shuttles. A restaurant may include a destination specific question offering validation at a parking location for a purchase of a menu item. In step 766, a device may insert incentive questions into a sequence of destination specific questions, if the device determined in step 764 that destination specific questions existed. The incentive questions may be inserted in any manner. The incentive questions may be inserted randomly. The incentive questions may be inserted in a ranked order. An incentive questions may be inserted every n number of destination specific questions.

A user device 701 may insert commercial incentive questions into the sequence of destination specific questions if it is determined in step 764 that commercial incentives to choose particular locations exist. A first question may be determined in step 768. A user device may determine a first question out of the set of destination specific questions if it is determined in step 764 that no commercial incentive questions exist. Alternatively, a user device may determine a first question out of the set of destination specific questions with inserted commercial incentive questions if it is determined in step in step 764 that commercial incentive questions exist. The first question may be the first question in the set of questions (e.g., the set of destination specific questions or the set of destination specific questions with inserted commercial incentive questions).

Destination specific questions may be provided as a question with a pull down menu containing relevant responses. A destination specific question may comprise a question of cost with a pull down menu containing a cost for economy parking and/or a cost for non-economy parking, for example, if the desired destination is an airport and two levels of parking pricing structure are available. A second destination specific question may comprise a question of availability of EV charging with a pull down menu containing a yes and a no, for example, if there are there are one or more parking locations but not all of the parking locations have EV charging available. A third destination specific question may comprise distance from the desired location, for example, if there are many parking locations, and/or if the user may or may not want to walk a certain distance. A fourth destination specific question may comprise ad space offering a user a discount at certain locations. The fourth destination specific question may comprise a question asking if the user would like to save $5 dollars with a pull down menu containing a yes or a no, for example, if one of the one or more parking locations is offering the savings. The parking locations and/or routes to the desired destination, affected or related by the destination specific questions, may be marked and/or identified. The parking location offering a savings may be marked and/or identified, for example, if the user highlights the yes in the pull down menu, so that the user knows the savings is for a particular parking location. A parking location and/or route may be marked and/or identified, for example, by highlighting, coloring, blinking, and/or increasing the brightness of the parking location and/or the route between the parking location and the desired destination.

In step 770, a user device may determine if a user answered the question. The question may be the first question determined in step 768, or the question may be the next question determined in step 780. The user device may determine that a user answered the question, for example, if the user selected an answer from a list of answers to a questions. The user device may determine that a user did not answer a question, for example, if the user did not select an answer from the list of answers to the question and the user indicated that no more questions will be answered (e.g., by pressing an end or submit button).

In step 772, a user device may determine the answer to the question if it was determined in step 770 that a user answered the question. The answer may be determined from the user selected answer. The answer may be selected from a pull down menu. The answer may be selected using a check box. The answer may be selected using a button.

Destination specific questions may be ranked by a user. It may be more important for a user, for example, to park close to a desired destination rather than to pay less to park. It may be more important for a user, for example, to pay less to park than to park in a covered parking lot. Destination specific questions may be given a number by a user indicating how important a destination specific question may be for a user. A user may rank a question up or down. A user may rank a question using a scale. A user may arrange questions in an order of personal importance.

In step 774, a user device may determine if a user provided a ranking for a question. The user device may determine if a ranking was given. The user device may determine a ranking may have been given, for example, if the user ranking is up or down, and the user pressed a thumbs up icon. The user device may determine a ranking may have been given, for example, if the user gave the question a score and the questions may be given a score.

In step 776, a user device may determine a rank of a question, for example, if it is determined in step 774 that the user ranked one or more questions. The user device may receive the score and/or convert symbols or rankings to a number score. A thumbs up or down ranking, for example, may be given scores of 1 or 0 respectively.

A user may or may not consider any sent destination specific questions in deciding their choice of parking location. A user may not consider any destination specific questions, if the user does not consider any of the destination specific questions significant in deciding their choice of parking location. A user may consider one or more destination specific questions, if the user considers the one or more destination specific questions significant in deciding their choice of parking location. The user may consider one of one or more of the destination specific questions significant in deciding on a parking location, for example, if one of the parking locations provides electric vehicle charging and the user would like to charge their electric vehicle. The user may consider a destination specific question significant, for example, if one of the parking locations is lower cost and the user would rather save money than have a shorter walk. The user may find a destination specific question significant, for example, if one of the parking locations is covered and the weather is poor.

In step 778, a user device may determine if more questions are available. The user device may determine if more questions are available, for example, if the user device determines the previous questions was not answered in step 770, if the user device determines that the question was not ranked in step 774, or if the ranking was determined in step 776. The user device may determine if more questions exist in the sequence of the set of destination specific questions. The user device may determine the length of the sequence of the set of destination specific questions and monitor the number of questions that are answered. The next question may be determined in step 780, for example, if it was determined more questions exist in step 778. The user device may determine if the next question is answered in step 770 and whether the next question was ranked in step 774.

A user device may store and/or send a set of answers to a set of destination specific question in step 782, if it is determined in step 778 that no more questions remain. The answers to the destination questions and the rankings to the destination questions may be saved locally on the user device and/or shared with a server (e.g., a first server). The answers may be used to determine a set of parking locations based on a user's answers to the destination specific questions. The answers may be stored and used to determine popularity and/or relevance of specific destination questions.

Returning to FIG. 7b, a user device 701 may receive a user's answers to a set of destination specific questions, and the answer's rankings, in step 730. A set of parking locations further based on a user's answers to the destination specific question may be determined in step 735, if it was determined in step 725 that the user answered any destination specific questions.

In step 740, a user device may provide a set of ranked parking locations (e.g., crowdsourced) to a user using a display device. The ranked parking locations may be based on a popularity ranking of parking locations (e.g., crowdsourced) contained in parking location data received in step 710 and determined in step 715. Alternatively, the ranked parking locations may be based on the popularity ranking of the parking locations received in step 710 that has been filtered based on answers to a set of destination specific questions and the rankings of those answers received in step 730 and determined in step 735.

A user may choose one of the parking locations contained in a set of ranked parking locations using an input device of a user device 701. In step 745, a user device 701 may send, and a server 702 may receive, the user's choice of parking locations so that the server may determine a final approach route to the chosen parking location. The server, in step 750, may determine the final approach route (e.g., based on crowdsourcing), and in step 755, the server 702 may send, and the user device 701 may receive, the final approach route to the chosen parking location. The user device 701 may display the route on a display device, and the user device 701 may provide line by line written and verbal instructions from a current location to the chosen parking location.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving information relating to a destination from a user;
determining a set of potential parking locations comprising one or more parking locations based on the information provided by the user;
selecting, based on parking location data, a preferred parking location from the set of potential parking locations; and
sending information relating to the preferred parking location to the user.

2. The method of claim 1, wherein determining the set of potential parking locations comprises:
receiving parking data corresponding to the destination, wherein the parking data comprises a popularity score for each of parking location in the set of potential parking locations; and
selecting potential parking locations using the popularity score.

3. The method of claim 1, wherein determining the preferred parking location comprises:
receiving parking data based on the destination, wherein the parking data comprises parking location popularity; and
determining the preferred parking location as the parking location, of the set of potential parking locations, having a highest popularity score.

4. The method of claim 1, further comprising:
sending one or more destination specific questions based on the destination;
receiving one or more answers to the one or more destination specific questions; and
wherein the selecting the preferred parking location is based on at least one of the one or more answers to the one or more destination specific questions.

5. The method of claim 1, further comprising:
sending the destination to a parking data server; and
receiving parking location data for the destination, wherein the parking location data comprises one or more of a parking location, a parking location popularity score, and one or more destination specific questions.

6. The method of claim 1, wherein the information relating to the destination comprises one or more of an address, a title, and geospatial coordinates.

7. The method of claim 1, further comprising:
sending the set of potential parking locations;
receiving a chosen parking location from among the set of potential parking locations; and
wherein the selecting the preferred parking location is based on the chosen parking location.

8. The method of claim 1, further comprising:
sending one or more destination specific questions, wherein the one or more destination specific questions comprise one or more of:
a parking location cost;
availability of electric vehicle charging at a parking location;
if a parking location is covered;
if a shuttle to a parking location is available; and
distance between a parking location and the destination.

9. The method of claim 1, wherein determining the set of potential parking locations comprises:
receiving parking location data comprising one or more parking locations and a parking location popularity score for each of the one or more parking locations;
receiving parking delay information of the set of potential parking locations comprising one or more of:
road closure information at the destination;
construction delay information at the destination; and
accident information at the destination; and
determining the set of potential parking locations based on the popularity scores of the one or more parking locations and the parking delay information of the one or more parking locations.

10. A method comprising:
sending, to a server, information relating to a destination
receiving, from the server, parking data comprising a set of potential parking locations based on the information relating to the destination;
selecting a first preferred parking location from the set of potential parking locations based on the destination and the parking data;
sending, to a server, the first preferred parking location; and
receiving data associated with the first preferred parking location comprising a route to first preferred parking location.

11. The method of claim 10, wherein the parking data comprises one or more of:
a parking location description;
a parking location address;
a parking location geospatial coordinates;
a parking location popularity;
one or more parking location destination specific questions;
a destination address; and
destination geospatial coordinates.

12. The method of claim 10, further comprising:
sending one or more destination specific questions based on the destination;
receiving answers to the one or more destination specific questions; and
wherein the determining the first preferred parking locations is based on one or more answers to the one or more destination specific questions.

13. The method of claim 10, wherein sending information relating to a destination comprises sending one or more of:
a name of a destination;
geospatial coordinates of a destination; and
an address of a destination.

14. The method of claim 10, wherein the parking data comprises one or more parking locations and popularity data of the one or more parking locations; and wherein the determining a first preferred parking location is based on the popularity data of the one or more parking locations.

15. The method of claim 10, further comprising:
determining directions from a current location to the first preferred parking location; and
creating a map from the current location to the first preferred parking location.

16. The method of claim 10, wherein the parking data comprises one or more parking locations and popularity data of the one or more parking locations; and further comprising:
sending one or more destination specific questions;
receiving one or more answers to the one or more destination specific questions;
receiving rankings of importance of the one or more destination specific questions; and
wherein the determining the first preferred parking location is based on one or more of the popularity data of the one or more parking locations, the answers to destination specific questions, and rankings of the destination specific questions.

17. A method comprising:
receiving information relating to a destination from a user device;
receiving, from a server, parking location data based on the information relating to the destination;
determining one or more potential parking locations and routes to the one or more potential parking locations based on the parking location data; and
selecting a preferred parking location from the one or more potential parking locations.

18. The method of claim 17, wherein the parking location data used for determining the one or more potential parking locations comprises popularity scores for each of the one or more potential parking locations; and wherein the determining the one or more potential parking locations is based on the popularity scores of the one or more potential parking locations.

19. The method of claim 17, further comprising:
determining directions to the preferred parking location from a current location;
determining directions from the preferred parking location to the destination; and
sending one or both of the directions to the preferred parking location from the current location and the directions from the preferred parking location to the destination.

20. The method of claim 17, wherein parking location data comprises popularity scores of the one or more potential parking locations; and further comprising:
receiving delay information of the one or more potential parking locations comprising one or more of:
road closure information at the destination,
construction delay information at the destination, and
accident information at the destination;
safe passage information to the destination; and
determining the preferred parking location based on the popularity scores of the one or more parking locations and the delay information of the one or more parking locations.
